(19) United States
(12) Patent Application Publication
(10) Pub. No.: US 2012/0036037 A1
(43) Pub. Date: Feb. 9, 2012

(54) Product reccommendation system

(75) Inventors: Quanwu Xiao, Hangzhou (CN); Ningjun Su, Hangzhou (CN); Chang Tan, Hangzhou (CN); Qi Liu, Hangzhou (CN); Jinyin Zhang, Hangzhou (CN); Enhong Chen, Hangzhou (CN)

(73) Assignee: Alibaba Group Holding Limited

(21) Appl. No.: 13/136,420

(22) Filed: Aug. 1, 2011

(30) Foreign Application Priority Data
Aug. 3, 2010 (CN) 201010246510.9

(51) Int. Cl. G06Q 30/00

(52) U.S. Cl. 705/26.7

(57) ABSTRACT

Product recommendation is disclosed, including retrieving user behavior data associated with a predetermined statistical period; sorting the user behavior data into one or more groups of data corresponding to one or more types of products based at least in part on associated product identifiers; determining a plurality of interest levels associated with the predetermined statistical period for at least one or more groups of data; determining a plurality of purchase peak probabilities using at least the plurality of interest levels, wherein a purchase peak probability is associated with a predicted likelihood of user interest in receiving recommendations associated with a type of product; ranking at least a portion of the plurality of purchase peak probabilities in response to receipt of an indication to present recommendation information; and presenting recommendation information based at least in part on the ranked at least portion of the plurality of purchase peak probabilities.

### CROSS REFERENCE TO OTHER APPLICATIONS

This application claims priority to People's Republic of China Patent Application No. 201010246510.9 entitled RECOMMENDATION INFORMATION OUTPUT METHOD, SYSTEM AND SERVER filed Aug. 3, 2010 which is incorporated herein by reference for all purposes.

### FIELD OF THE INVENTION

The present application involves the field of network technology. In particular, it involves a system, method, and server for recommending information.

### BACKGROUND OF THE INVENTION

Online shopping has become a common form of shopping. In the course of a user's browsing session at a merchant's website, a recommendation window associated with the website may recommend popular products to the user and also display information concerning such products on the web page for the user's view. Typically, recommendations (e.g., of products) are made primarily based on the purchase volume of certain items and/or user interest in the items. For example, in a typical technique of recommending information, if the number of purchases of a particular product exceeds a certain threshold number, then the information related to the product is recommended to a user; or, if the click traffic for a certain product exceeds a certain threshold number, then the information for the product is recommended to a user.

One drawback of the typical approach to making recommendations is that it overlooks the effects of the time factor (e.g., the lag between accumulating purchase volume and click traffic information and using such information in making product recommendations). For example, sometimes a user's product purchasing patterns change from season to season. The user may tend to purchase and/or browse for more short-sleeved apparel in the summer season and so later, such as when the winter season arrives, the cumulative sales volume and/or click traffic for short sleeve apparel is relatively high. Based on the typical approach, because the cumulative sales volume and/or click traffic for short sleeve apparel is high, short sleeve apparel will be recommended to users. However, in this example, by the time winter arrives, users are mostly likely no longer interested in receiving product recommendations related to short sleeve apparel. Likewise, during the winter season, the purchase volume and/or click traffic for winter apparel may dramatically increase. But later, such as by the time the spring or summer season arrives, products related to both short sleeve and winter apparel may be recommended to users, which may be undesirable since it is unlikely that users would need both short sleeve and winter apparel around the same time. Nevertheless, the occurrence of unnecessary recommendations could needlessly consume limited network resources by causing an increase in the volume of data transmitted in the network and reducing network data transmission speeds. Meanwhile, in order to prevent the occurrence of the aforementioned inaccuracies in recommendation information, typical recommendation engine servers typically employ a manual technique to revise recommendation. information such that stored recommendation information is used to make recommendations at appropriate times. However, the work load to manually revise recommendation information is relatively heavy and the automation level is low, which makes it difficult to take full advantage of the computing capacity of the recommendation engine server.

### BRIEF DESCRIPTION OF THE DRAWINGS

Various embodiments of the invention,are disclosed in the following detailed description and the accompanying drawings.

In order to more clearly describe the technical proposals of the embodiments of the present application or the existing technology, the following are brief overviews of the drawings that need to be used in describing the embodiments or existing technology; obviously, the drawings in the descriptions below are only some of the embodiments stated in the present application; for ordinary technical personnel in this field, on the premise that no additional creative labor is expended, other drawings can be obtained.

FIG. 1 is a diagram showing an embodiment of a recommendation system.

FIG. 2 is a flow diagram showing an embodiment of a process for making recommendations.

FIG. 3 is a flow diagram showing an embodiment of a process of making recommendations.

FIG. 4 is a diagram showing an embodiment of the recommendation system.

FIG. 5 is a diagram showing an embodiment of a recommendation information output server.

FIG. 6 is a diagram showing an embodiment of a recommendation information output server.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

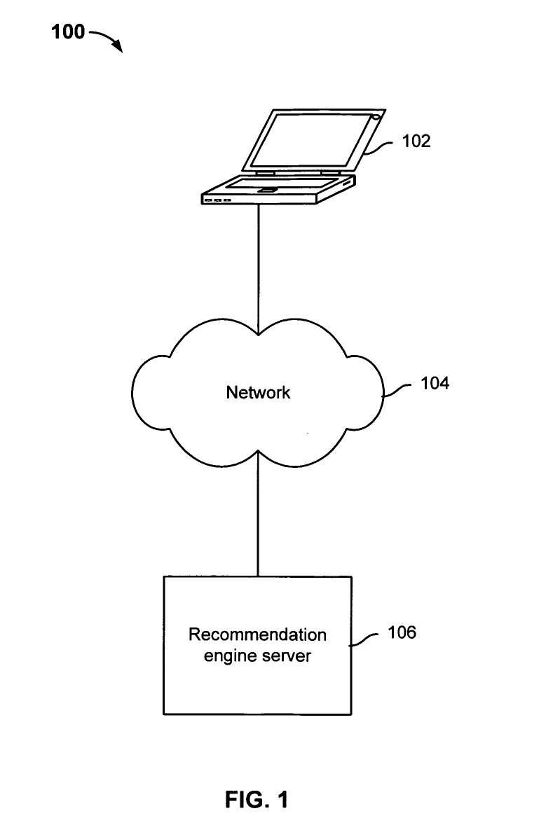

FIG. 1 is a diagram showing an embodiment of a recommendation system. System 100 includes device 102, network 104, and recommendation engine server 106. Network 104 includes any high speed data and/or telecommunications network.

Device 102 is configured to run an application such as a web browser through which a user can access a website. In various embodiments, a user uses device 102 to access an electronic commerce website at which the user can receive product recommendations. In some embodiments, the user can receive product recommendations based on the current time or date at which the user is browsing the website. Examples of device 102 include a desktop computer, a laptop computer, a handheld device, a smart phone, a tablet, a mobile device, or any other hardware/software combination that supports client access.

Recommendation engine server 106 is configured to determine purchase peak probabilities (e.g., that vary over a span of time, such as a statistical period) for one or more products and to output recommendation information (e.g., recommendations for users to buy one or more types of products) based at least in part on the purchase peak probabilities. Purchase peak probabilities indicate, for a product, at each interval over a period of time (e.g., a statistical period), the predicted likelihood that users would be interested in receiving recommendations associated with that product at that time interval. In some embodiments, recommendation engine server 106 is configured to retrieve data from a user behavior data database and to sort the data into groups, based on product identifiers associated with the retrieved behavior data. In some embodiments, recommendation engine server 106 is configured to determine, for each type of product, a time sequence associated with each type of user behavior data. In some embodiments, recommendation engine server 106 is configured to use all the time sequences for different types of user behavior data associated with a product and determine a time sequence of interest levels for the product. In some embodiments, recommendation engine server 106 is configured to determine a time sequence of purchase peak probabilities for a product based on the time sequence of interest levels for the product. In some embodiments, recommendation engine server 106 is configured to receive an indication to output recommendations and in response, rank a least a portion of purchase peak probabilities (e.g., corresponding to the current day and month) associated with one product with at least a corresponding portion of purchase peak probabilities associated with other products. In some embodiments, recommendation engine server 106 outputs recommendations based on products whose corresponding purchase peak probabilities rank high among the ranked list. For example, for a given time interval (e.g., a certain day and month) for which a product recommendation is to be made, the purchase peak probabilities of various products at that time interval are retrieved (e.g., from a database). The retrieved purchase peak probabilities associated with the given time interval are ranked and those products whose purchase peak probabilities rank high among the ranked list are determined to be recommended. Stored product information (e.g., price, manufacturer, model, specifications, product reviews, etc.) corresponding to those products is retrieved and then formatted to be displayed at the electronic commerce website.

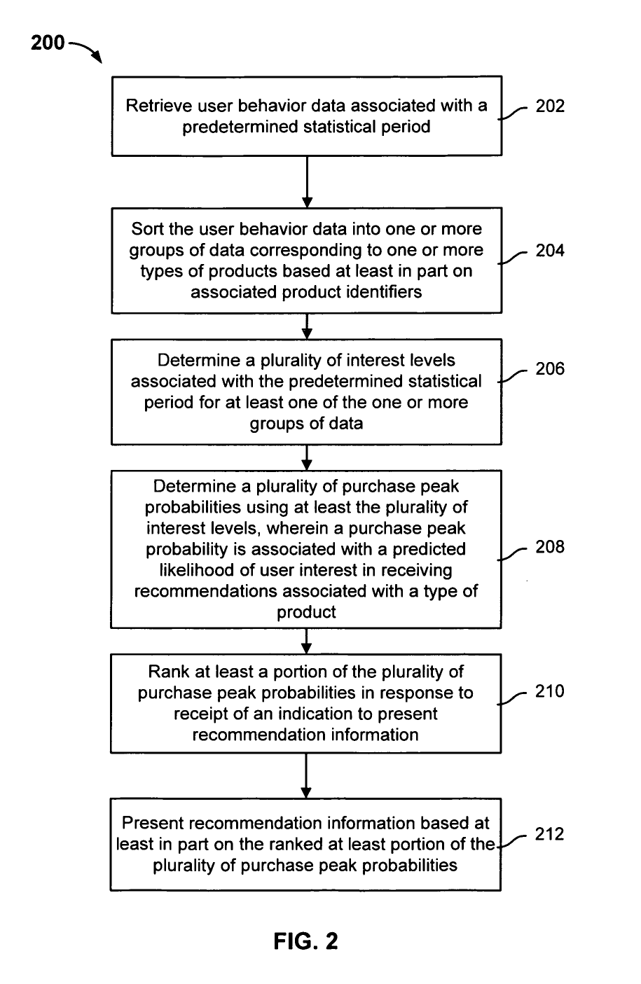

FIG. 2 is a flow diagram showing an embodiment of a process for making recommendations. In some embodiments, process 200 can be implemented at system 100.

At 202, user behavior data associated with a predetermined statistical period is retrieved.

In various embodiments, user behavior data involving the interactions of users at an electronic commerce website is stored at a database for storing user behavior data. In various embodiments, various different types of user behavior data are stored at the user behavior data database. Examples of types of user behavior data include: click traffic at a webpage of the website that is associated with a particular product, page views, browsing times, and purchase amounts with respect to the product. In some embodiments, each type of user behavior data is stored with its respective product identifier. This way, when user behavior data of one or more types needs to be retrieved for a certain type of product, such data can be searched for using the product identifier associated with that type of product. In various embodiments, the user behavior data database stores data associated with various products (e.g., that are associated with the electronic commerce website). In various embodiments, the user behavior data database includes one or more tables for storing user behavior data. Whenever a user completes an instance of user behavior (e.g., via an interaction with the web browser that is used to view the website), a recommendation engine server associated with the electronic commerce website saves the behavior data in a corresponding section of a table in the user behavior data database.

Information stored in the user behavior data database may be organized in a variety of ways. In some embodiments, in the user behavior data database, behavior data of different users with respect to the same product may be saved using different tables. In some embodiments, user behavior data is stored at the database with timestamps related to the time at which such data was stored at the database. When user behavior data is to be processed, one or more tables in the user behavior database can be searched based on the start and end times of a predetermined statistical period. In various embodiments, a predetermined statistical period is a duration of time set by an administrator of the recommendation engine server that is used to indicate a period for which user behavior data with associated timestamps that fall within the period is to be analyzed for the purpose of making recommendations. For example, a predetermined statistical period can be specified in months, weeks, or days, depending on the frequency or volume of sales per each period of time. For example, if certain products are frequently purchased daily, then a statistical period can be the length of a day; if certain products are not frequently purchased over the length of a day but are frequently purchased over the course of a week, then the statistical period can be the length of a week; if certain products are not frequently purchased over the length of a week but are frequently purchased over the course of a month, then the statistical period can be the length of a month. In some embodiments, the user behavior data that falls within the statistical period can be retrieved from one or more tables and one or more data summary tables can be generated with the retrieved data. In some embodiments, the data summary table may include user behavior data occurrence dates, product identifiers, user identifiers and the relevant number of behavior data, for example.

At 204, the user behavior data is sorted into one or more groups of data corresponding to one or more types of products based at least in part on associated product identifiers.

In various embodiments, the user behavior data retrieved at 202 and stored in a summary data table includes data associated with more than one type of product. In order to perform analysis for each type of product included in the user behavior data, the data needs to be sorted into groups, where each data group corresponds to a type of product. A type of product is identified by an associated product identifier. In some embodiments, the product identifier uniquely identifies one type of product. In some embodiments, the retrieved user behavior data is sorted into groups of data corresponding to different product types based at least in part on the product identifiers of the retrieved user behavior data. In various embodiments, each group of data that corresponds to a type of product includes different types of user behavior data that correspond to that product. For example, the group of data associated with the product type of Product A could include data related to the user behavior data types of click traffic at a webpage of the website that is associated with Product A, page views of the webpage associated with Product A, browsing times at the webpage associated with Product A, purchase amounts of Product A, purchased amounts with respect to Product A, or a combination thereof.

At 206, a plurality of interest levels associated with the predetermined statistical period for at least one of the one or more groups of data is determined, wherein a purchase peak probability is associated with a predicted likelihood of user interest in receiving recommendations associated with a type of product.

In various embodiments, one or more time sequences are associated with a type of product for a predetermined statistical period. As used herein, the time sequence is a series of time intervals within the duration of the predetermined statistical period with corresponding user behavior data information for a particular product. In some embodiments, the duration of each time interval is set by an administrator of the recommendation engine server, based on, for example, empirical data such as knowledge about how time affects users' behavior with respect to the product and/or automated techniques. For example, if the users' behavior may change greatly from day to day, the statistical period is set to be one year and each time interval is set to be one day, and the time sequence associated with the statistical period would include 365 time intervals. If the users' behavior with respect to a product may change based on seasonal changes for the statistical period of one year and, if each time interval is set to be one season, then the time sequence associated with the statistical period would include 4 time intervals. In some embodiments, the duration of each time interval is automatically determined using techniques such as machine learning. For example, machine learning can be applied to detect patterns/frequencies of user behavior over time to determine a suitable duration for a time interval within the statistical period. In some embodiments, each time interval in the time sequence associated with a particular product is associated with information associated with a certain type of user behavior data (e.g., click traffic, page views, browsing times, and purchase amounts and purchase quantities) associated with that particular time interval.

In various embodiments, a weight (e.g., a scaling factor, a constant value) is attributed to each time sequence that is associated with a type of user behavior. In some embodiments, weights to be attributed to each time interval of a time sequence can be determined through training statistical models, machine learning, and neural networks to obtain desired weight values. Then, once weights have been attributed to all the time sequences of different types of user behavior data associated with a particular product, a time sequence of interest levels can be computed for the particular product. In some embodiments, a time sequence of interest levels for a particular product can be determined with a linear combination of all the time sequences associated with different types of user behavior data for that particular product.

At 208, a plurality of purchase peak probabilities is determined using at least the plurality of interest levels.

In some embodiments, purchase peak probabilities are determined for each type of product that the time sequence of interest levels computed for that type of product. Using the time sequence of interest levels, an average interest level can be computed and then a threshold interest level value can be determined based on the average interest level value. In various embodiments, a purchase peak probability for each time interval can be determined using the average and threshold interest level values. For example, each interest level value (which corresponds to a time interval in the statistical period) can be compared to the average interest level value and separately against the threshold interest level value. The results of the comparisons can be used, for example, as follows: the purchase peak probability of interest level values lower than the average interest level value can be set to 0 and the purchase peak probability of interest level values higher than the described threshold interest level value can be set to 1, and purchase peak probabilities for interest level values between the average and threshold values are determined based on a formula using the average and threshold interest level values.

At 210, at least a portion of the plurality of purchase peak probabilities is ranked in response to receipt of an indication to present recommendation information.

In some embodiments, an indication to output recommendation information is received when a user browses a webpage at an electronic commerce website, clicks on a particular element on a webpage, or otherwise interacts with the electronic commerce website.

In some embodiments, at least a portion of the plurality of purchase peak probabilities associated with one type of product is ranked among portions of purchase peak probabilities associated with other products. For example, given a time interval (e.g., a day in a month), the purchase peak probability associated with that time interval for multiple products can be ranked from highest to lowest. Then, the products associated with relatively higher purchase peak probabilities can be recommended to users at a time interval associated with the previous time interval. For example, if purchase peak probabilities were ranked for products associated with May 1, 2010, then products can be recommended based at least in part on those rankings for May 1, 2011 (assuming that user's buying habits remain consistent over the subsequent year, and depending on the time/season of each particular year).

At 212, recommendation information is presented based at least in part on the ranked at least portion of the plurality of purchase peak probabilities.

In some embodiments, existing recommendation information is adjusted based at least in part on the ranked purchase peak probabilities. For example, existing recommendation information can include information that is determined based on typical techniques (e.g., accumulation of click traffic and/or purchase volume).

In some embodiments, the determined purchase peak probabilities can be used as follows:

1) Direct screening of recommendation results—Some initial recommendation results are obtained and the recommendation results are ranked based on purchase peak probabilities, from the highest to the lowest, and the rankings of hot-selling products are brought forward (those products with purchase peak probabilities that are ranked higher in the ranked list). For example, the recommendation results of products to the user that are obtained based on typical techniques (e.g., based on the accumulation of click traffic and/or purchase volume) may indicate to recommend winter apparel. However, the purchase peak probability for t-shirts is higher than that for winter apparel. By using the purchase peak probabilities for t-shirts and winter apparel, the recommendation results can be adjusted to recommend t-shirts, instead of winter apparel.

2) Use of a recommendation system to screen hot-selling products—In some embodiments, it may only be desirable to display only a small number of recommended products. For example, it is desired to display only ten products. However, in some embodiments, a recommendation system requires that information regarding all products (which could include thousands of products) be entered into the recommendation system. In order to reduce the workload of the recommendation system, an initial screening of products that are near the top of the rankings based on the products' purchase peak probabilities can be performed. For example, the products ranked in the top 200 positions can be screened out and entered into the recommendation system for processing.

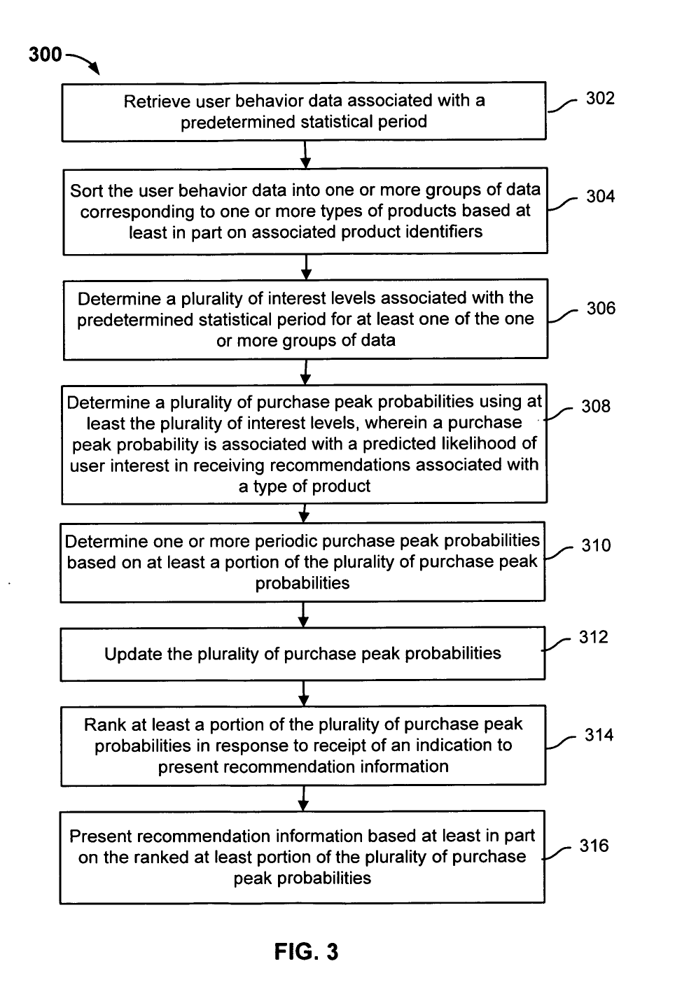

FIG. 3 is a flow diagram showing an embodiment of a process of making recommendations. In some embodiments, process 200 can be implemented using process 300. In some embodiments, process 300 can be implemented at system 100.

In some embodiments, process 300 is started in response to a trigger. For example, process 300 can be started automatically at the end of each period (e.g., as set up by a system administrator) for starting such a process.

At 302, user behavior data associated with a predetermined statistical period is retrieved.

Similar to what is described for 202 of process 200, user behavior data involving the interactions of users at an electronic commerce website is stored at a database for storing user behavior data.

User behavior data can be retrieved from the user behavior data database and input in a summary data table based on the predetermined statistical period. For example, if the user data is for the statistical period of the year between May 1, 2010 and Apr. 30, 2011, then data with timestamps that fall within that time period are retrieved from the user behavior data database and input into a data summary table, as shown in Table 1 below. In the example, the data summary table includes the following fields: date (day that the user behavior data occurred), user ID, product ID, and different types of user behavior data (click traffic, page views, and purchase amounts):

TABLE 1

| | User | Product | Click | Page | Purchase |
|---|---|---|---|---|---|
| Date | ID | ID | traffic | views | amount |
| 2010 May 1 | UserA | Product1 | 3 | 5 | 10.00 |
| 2010 May 1 | UserA | Product2 | 4 | 6 | 0.00 |
| 2010 May 1 | UserA | Product3 | 1 | 0 | 0.00 |
| 2010 May 1 | UserB | Product2 | 10 | 12 | 20.00 |
| 2010 May 2 | UserB | Product2 | 1 | 3 | 0.00 |
| 2010 May 2 | UserC | Product2 | 2 | 5 | 15.00 |
| 2010 May 2 | UserC | Product4 | 5 | 7 | 5.00 |
| . . . | . . . | . . . | . . . | . . . | . . . |

At 302, the user behavior data is sorted into one or more groups of data corresponding to one or more types of products based at least in part on associated product identifiers.

As Table 1 shows, each entry of a type of user behavior data (click traffic, page views, purchase amount) in the data summary table includes the total user behavior data for a particular user (e.g., UserA, UserB, UserC) on a particular day with respect to a particular product. In the example, the table records the many-to-many relationships of multiple users and multiple products. In order to perform the following determinations of product purchase peak probabilities, the data of Table 1 can be extracted and sorted into groups of data, where each group includes only data associated with a particular product. For example, to create a group of data related to Product2, using the product ID of Product2 as the search query, the set of various types of user behavior data including click traffic, page views, and purchase amounts for all users with respect to Product2 within the statistical period (e.g., one year) are extracted from Table 1.

At 306, a plurality of interest levels associated with the predetermined statistical period for at least one of the one or more groups of data is determined.

In various embodiments, data associated with the various types of user behavior data for a particular product is merged through determining a corresponding time sequence of interest levels for the particular product.

For example, assume that x1(t) expresses the total quantity of user purchases (which is an example of a type of user behavior data) of a particular product (e.g., Product X) at time interval t. Thus, the time sequence {x1}={x1(t), t=1, 2, . . . n} expresses the set of quantities purchased of a Product X during the time intervals from t=1 to t=n. For example, t=1 to t=n can represent each day in a year (i.e., n=365) or it can represent each week in a year (i.e., n=52). In the example, x1(t) represents the sum of quantities purchased by all users during time interval t. Assume that the statistical period is May 1, 2010 through Apr. 30, 2011, then time interval t=1 refers to the first time interval in the time sequence, i.e., the day May 1, 2010. In the example of Table 1, the time sequence {x1} represents the set of total quantities of user purchases of Product X over the course of the statistical period (e.g., May 1, 2010 to Apr. 30, 2011) at each one day time interval. Similarly, the time sequences corresponding to different types of user behavior data, such as number of page views, number of feedback comments, and click traffic can be represented by {x2}, {x3} and {x4}, respectively. The types of user behavior data are not necessarily limited to the four types mentioned above (quantities purchased, number of page views, and click traffic), which are used for only exemplary purposes.

In the example of Table 1, the time interval is a one day. In Table 1, the information for Product1, for example, for the type of user behavior data of number of page views for one date (e.g., Jan. 5, 2010) is obtained by adding together the number of page views from all users on that date. Supposing a particular day (e.g., Jan. 5, 2010) is selected as time interval t=1, and the duration of the statistical period is determined to be n, then the time sequence {x2} for the type of user behavior data of the number of user page views for Product1 can be obtained. This time sequence would represent the set of user page view traffic for Product1 for each of n days following the starting point at the particular day that corresponds to t=1. The time sequence can be expressed as{x2}={x2(t), t=1, 2, . . . , n}, where n is the number of time intervals within the predetermined statistical period.

Once a time sequence has been determined for each type of user data behavior for a particular product, a time sequence of interest levels can be determined for that particular product. For example, the time sequence of interest levels of users for a particular product can be represented as {X}={X(t), t=1, 2, . . . , n}, where {X} represents the user interest levels in the product within the statistical period t=1 to t=n and, where X(t) represents the interest level value for the product at time interval t. X(t) can be a linear combination of user behavior data; for example, assume that there is a total of m types of user behavior data, then X(t) can be computed using the following formula:

{X(t)}=w1{x1(t)}+w2{x2(t)}+ . . . +wm{xm(t)} (1)

In the formula above, w1, w2, . . . , wm are the weights attributed to each type of user behavior data for the product. Weights represent the proportional importance of each type of user behavior data relative to the interest level for the product. The computation of the values of the weights may be obtained, for example, through the establishment of user behavior models, the application of machine learning methods, and the use of BP neural networks. In some embodiments, the values of w1, w2, . . . , wm can be different for each type of product, and can be trained and obtained separately using the same or different neural networks.

At 308, a plurality of purchase peak probabilities is determined using at least the plurality of interest levels, wherein a purchase peak probability is associated with a predicted likelihood of user interest in receiving recommendations associated with a type of product.

There is generally an upward trend line in the time sequence of interest levels for each product, i.e., the interest level values in the earlier time intervals are more often than not lower than interest level values of later time intervals. This is because when a product has just been introduced at the electronic commerce website, more often than not the user behavior values for the product are not as great as they would be after the product has been available for a period of time. For example, there may be relatively few user click traffic for a particular product during the first week in which the product is introduced, but a month later, the user click traffic may increase substantially. In some embodiments, it is desirable to eliminate the aforementioned rising trend in interest levels over time. To counter this rising trend, a spline approximation function can be used, for example, to approximate a linear function of the time sequence of interest levels. This linear function can be subtracted from the time sequence of interest levels. For example, if the approximated linear function is y(t)=10t, then the time sequence of interest levels after the rising trend has been eliminated would be {X}={X(t)−10t, t=1, 2, . . . n}.

Assume that {X}={X(t)−10t, t=1, 2, . . . , n} represents the time sequence of interest levels after the rising trend has been eliminated. For convenience of description, in the remainder of the present application, {X}={X(t), t=1, 2, . . . , n} will generally represent an exemplary time sequence of interest levels, where {X} is a set of n discrete values having abscissa t. Assuming that the chosen time interval is one day, each discrete value would represent the user interest level value on a particular day. Then the average (avg) interest level of the time sequence of interest levels can be computed using the following formula, for example:

avg=(X(1)+X(2)+ . . . +X(n))/n (2)

In the above formula, n represents the total number of time intervals in the time sequence.

Each value of X(t) (i.e., interest level) is compared to the avg value, and for the time intervals whose interests are less than the avg value, their the purchase peak probabilities p are set to 0, i.e., to represent that it is very unlikely for these time intervals to correspond to times at which there is peak interest in the product.

For the time intervals whose interest levels are greater than the avg value, a threshold value z is computed to determine the purchase peak probabilities p corresponding to those time intervals. For example, z can be computed using the following formula:

z=(Xmax−avg)×0.6

In the above formula, Xmax is the maximum value in {X}={X(t), t=1, 2, . . . , n}. In some embodiments, the value of X(t) is compared to z, and the peak probabilities p corresponding to time intervals whose interest level values are greater than z are set to 1, i.e., to represent that these points are considered to be peak values. It should be noted that 0.6 in the formula above is a selected value and can be chosen to be any other value.

Finally, for the time intervals whose interest levels are between the threshold value z and the avg value, their corresponding purchase peak probabilities p can be computed using the following formula, for example:

p=(X(t)−avg)/(z−avg)

A time sequence associated with the purchase peak probabilities for a product as obtained through the techniques as described above can be represented by {p}={p(t), t=1, 2, . . . , n}.

The following method can be used to calculate product purchase periods:

The determined time sequence of interest levels {X} in products and the time sequence of peak probabilities {p} (determined using {X}) can be used to determine user purchase periods within the statistical period. In some embodiments, a purchase period refers to a recurring period (e.g., a statistical period can include more than one of these recurring periods) in which at least a certain type of user is likely to buy one or more products. For example, a user that works with a factory that includes an assembly line may need to buy products such as raw materials in a regular quantity and at a regular period (e.g., when raw materials become low). In another example, a user that works with a retail store may also need to buy products (e.g., apparel) in a regular quantity and at a regular period (e.g., at the start of each season). Once a purchase period is determined, a recommendation system could forecast that one or more users will have a high chance of purchasing a certain product associated with the purchase period, each time the purchase period recurs and therefore recommend the certain product around the time of the purchase period. In some embodiments, user purchase periods can be determined as follows:

First, FFT (Fast Fourier transform) can be used to perform calculations on the time sequence of interest levels {X} to obtain the strongest sine component contained therein, and the potential purchase period L is determined based on this sine component. After the potential purchase period L has been determined, time sequence {X} is broken into a number of time segments of the length L (e.g., L can span one or more time intervals), and the interest level values of the time segments are compared to each other for similarity. If interest levels associated with the time segments are similar, then a user purchase period is considered to exist during those time segments. In some embodiments, fuzzy matching of peak probabilities may be used when performing the cosine comparison (e.g., cosine similarity) method may be used. For example, assuming two time segments {P} and {Q} (which are both part of the time sequence of interest levels {X}) are determined to be of equal length, the cosine value is computed using the following formula:

$${cosine}_{\{ P \} \{ Q \}} = \frac{{p}_{1} {q}_{1} + {p}_{2} {q}_{2} + … {p}_{n} {q}_{n}}{\sqrt{{p}_{1}^{2} + {p}_{2}^{2} + … {p}_{n}^{2}} \sqrt{{q}_{1}^{2} + {q}_{2}^{2} + … {q}_{n}^{2}}} \qquad ( 3 )$$

In the formula above, the closer the cosine value is to 1, the greater the similarity between the two time sequences {P} and {Q} (each is of L length in time), which is used to confirm the existence of purchase period. If {P} and {Q} are determined to be similar, then in some embodiments, both {P} and {Q} are considered to be purchase periods.

At 310, one or more periodic purchase peak probabilities are determined based on at least a portion of the plurality of purchase peak probabilities.

In some embodiments, when there is the possibility that a purchase period exists or a purchase period has already been confirmed, the purchase peak probabilities across multiple different products (e.g., assume that there k number of products) can be compared to determine multiple product average peak probability pa.

pa(t)=(p1(t)+p2(t)+ . . . +pk(t))/k (4)

Where p1, p2, . . . , pk each represent the peak probability for each product at time interval t (in some embodiments, t is within one or more identified purchase periods); here, time intervals have purchase peak probabilities that are set to p=1 if the corresponding interest level values are above a certain threshold (e.g., z), time intervals have purchase peak probabilities that are set to p=0 if the corresponding interest level values are below the average interest level value, and time intervals have purchase peak probabilities set to a p value that is based on a formula that uses both the threshold and average interest level values. If pa(t) exceeds a predetermined threshold value, then the time interval t can be considered to be a periodic purchase peak time interval (i.e., a peak interest time across multiple products), and pa(t) can be recorded as a periodic peak probability value, i.e., the pa value will be stored for the k products at time interval t, and when making recommendations, those products can be recommended at the identified time interval t.

At 312, the plurality of purchase peak probabilities is updated.

In various embodiments, the purchase peak probabilities are stored. In some embodiments, the information is stored to a product purchase peak data table associated with the particular product. In some embodiments, the product purchase peak data table can include, for example, fields such as Product ID, peak value time intervals, and corresponding peak probabilities. In some embodiments, the product purchase peak table also includes entries for periodic purchase peak probabilities and their corresponding period lengths.

In some embodiments, the product purchase peak data table can be saved to a product purchase peak database. In some embodiments, the same or different database can be used to store product information, including product classification information, whether or not the product exists, the duration of the product's existence, product description information, etc. In some embodiments, basic information about a product may change over time, and therefore the stored basic information can be updated on a real-time basis to reflect such changes. In various embodiments, basic product information can serve as a reference for the determination of purchase peak probabilities. For example, for products which no longer exist (e.g., products that are no longer available for sale at the electronic commerce website), the determination of purchase peak probabilities and purchase periods can be terminated and product information related to these products can be deleted from the one or more databases. For products that have existed for a relatively short time (e.g., products that have been available at the electronic commerce website for only a short period of time), the determination of the purchase peak probabilities and purchase periods can be delayed until the corresponding durations are sufficiently long and there is sufficient user behavior data.

At 314, at least a portion of the plurality of purchase peak probabilities are ranked in response to receipt of an indication to present recommendation information.

The determined product purchase peak probabilities can be applied to correct recommendation information that is determined based on typical techniques (e.g., accumulation of click traffic and/or purchase volume). In some embodiments, during correction of recommendation information, the time interval (e.g., corresponding to a date and/or time) on which recommendations are to be made is used as the query to search through saved product purchase peak data tables so that the peak probabilities for each product at that time interval can be obtained. Then, based on the ranking of peak probabilities, only information that is ranked near the top is recommended to users because the higher the peak probability, the more likely a product is to become a hot-selling product. In other words, in some embodiments, given a time interval (e.g., the day in a month), the purchase peak probabilities of one or more products are searched to find the purchase peak probabilities of those products associated with the given time interval (e.g., the same day and month in a previous year that is included within the statistical period for which the purchase peak probabilities were determined). Then, the returned purchase peak probabilities are ranked and those products that correspond to higher purchase peak probabilities for the given time interval will be recommended to users.

At 316, recommendation information is presented based at least in part on the ranked at least portion of the plurality of purchase peak probabilities.

In some embodiments, one or more of the following techniques can be used to adjust recommendation information:

1) Direct screening of recommendation results—Some initial recommendation results are obtained and the recommendation results are ranked based on purchase peak probabilities from highest to lowest, and the rankings of hot-selling products are brought forward. For example, the recommendation results of products the user may like based on typical techniques (e.g., accumulation of click traffic and/or purchase volume) may indicate to recommend winter apparel. However, the purchase peak probability for t-shirts is higher than that for winter apparel. By using the peak probabilities for t-shirts and winter apparel, the recommendation results can be adjusted to recommend t-shirts, instead of winter apparel.

2) Use of recommendation system to screen hot-selling products—In some embodiments, it may only be desired to display only a small number of recommended products. For example, it is desired to display only ten products. However, in some embodiments, a recommendation system requires that information regarding all products (which could include thousands of products) be entered into the recommendation system. In order to reduce the workload of the recommendation system, an initial screening of products that are near the top of the rankings based on the products' purchase peak probabilities can be performed. For example, the products ranked in the top 200 positions can be screened out and entered into the recommendation system for processing.

In various embodiments, processes 200 and 300 can be performed on one or more servers (e.g., a recommendation engine server). In some embodiments, the functions of processing user behavior data in order to determine purchase peak probabilities and purchase periods can be performed on and/or by one server, and the functions of storing and maintaining purchase peak probabilities, purchase periods and product information can be performed on and/or by another server, thereby achieving load balancing. In some embodiments, the functions of the two servers described above can also be executed on one server. The functions of the two servers described above can be executed offline. For example, when recommendation information needs to be outputted, the online information recommendation server communicates via TCP/IP protocol with the server where the purchase peak probabilities and purchase periods are stored to obtain the purchase peak probabilities, and outputs product recommendation information based on the corresponding ranking results.

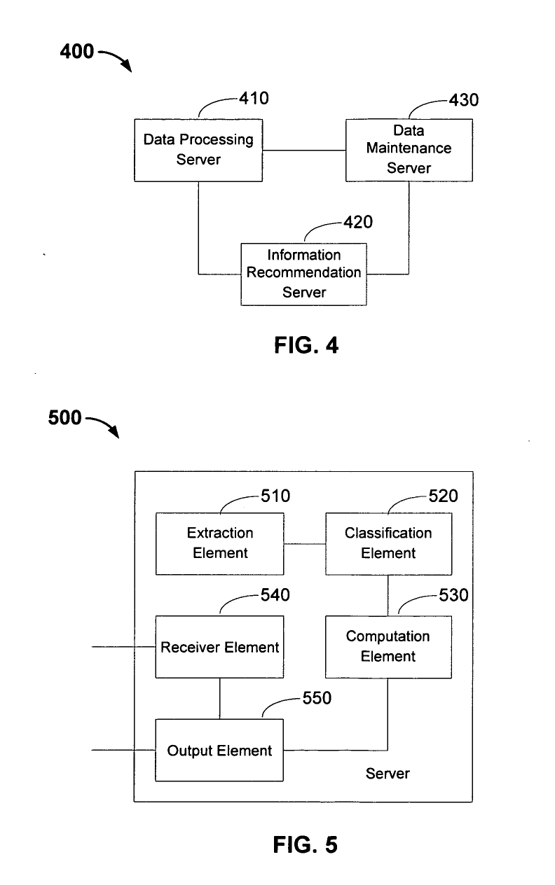

FIG. 4 is a diagram showing an embodiment of the recommendation system.

System 400 includes: data processing server 410, information recommendation server 420, and data maintenance server 430.

Data processing server 410 is configured to retrieve user behavior data associated with a predetermined statistical period from a user behavior data database, sort the described user behavior data based on product identifiers associated with the data, determine a time sequence of interest levels for each type of product based on the retrieved data, and determine the purchase peak probabilities for the products based on the time sequences of interest levels.

Information recommendation server 420 is configured to, upon receipt of an indication to output recommendation information, retrieve the determined purchase peak probabilities for each type of product from the data processing server 410, rank the purchase peak probabilities in order from highest to lowest, and output product recommendation information based on the ranking results.

Data maintenance server 430 is configured to store the purchase peak probabilities of the products, and to perform updates of the peak probabilities of the products based on updated information that is received.

FIG. 5 is a diagram showing an embodiment of a recommendation information output server.

Server 500 includes: extraction element 510, classification element 520, computation element 530, receiver element 540, and output element 550. In some embodiments, the extraction element, classification element, and computation element are implemented using one or more processors, and the receiver element and output element are implemented using communication interfaces.

Extraction element 510 is configured to retrieve user behavior data associated with a predetermined statistical period from the user behavior data database.

Classification element 520 is configured to sort the user behavior data based on product identifiers associated with the data and to obtain a time sequence of interest levels for each type of product based on the retrieved data.

Computation element 530 is configured to determine the purchase peak probabilities for the products based on the time sequence of interest levels.

Receiver element 540 is configured to receive indications to output recommendation information.

Output element 550 is configured to rank the purchase peak probabilities in order from highest to lowest and output recommendation information based on the results of the ranking.

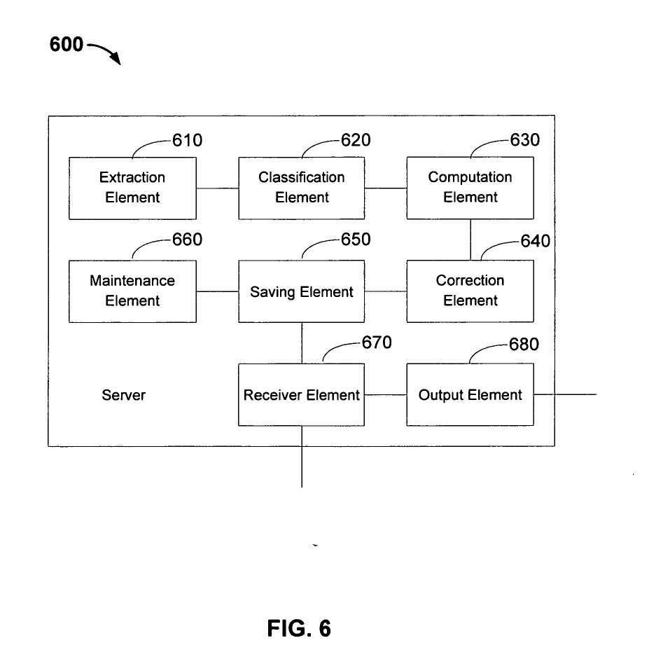

FIG. 6 is a diagram showing an embodiment of a recommendation information output server.

Server 600 includes: extraction element 610, classification element 620, computation element 630, correction element 640, saving element 650, maintenance element 660, receiver element 670, and output element 680. In some embodiments, the elements are implemented as a combination of hardware and software and are also implemented across one or more devices. In some embodiments, the extraction element, classification element, computation element, correction element, saving element, and maintenance element are implemented using one or more processors, and the receiver element and output element are implemented using communication interfaces.

Extraction element 610 is configured to retrieve user behavior data associated with a predetermined statistical period from the user behavior data database.

Classification element 620 is configured to sort the user behavior data based on product identifiers associated with the data and to obtain a time sequence of interest levels for each type of product based on the retrieved data.

Computation element 630 is configured to determine the purchase peak probabilities for the products based on the time sequence of interest levels and to compute the purchase periods for the products based on the time sequences of interest levels.

Correction element 640 is configured to determine the periodic purchase peak probabilities for the products.

Saving element 650 is configured to store the purchase peak probabilities for the products.

Maintenance element 660 is configured to update the purchase peak probabilities for the products at predetermined time intervals based on updates of information related to the products.

Receiver element 670 is configured to receive indications to output recommendation information.

Output element 680 is configured to rank the purchase peak probabilities in order from highest to lowest and to output product recommendation information based on the results of the ranking.

In some embodiments, extraction element 610 may include (not shown in FIG. 6): A database search element that is configured to search data tables in the user behavior data database based on the start and end times of the predetermined statistical period; a summary table generation element that is configured to retrieve user behavior data matching the predetermined statistical period from the data tables and generate data summary tables, where the summary data tables can include dates, product identifiers, user identifiers, and a number of types of user behavior data.

In some embodiments, classification element 620 may include (not shown in FIG. 6): A data extraction element that is configured to extract all retrieved user behavior data that is associated with the same product identifier; a time sequence generation element that is configured to summarize, for all retrieved data associated with the same product identifier, each type of user behavior data, and to generate a time sequence for each type of user behavior data; and a time sequence computation element that is configured to compute the time sequence of the interest levels for the products by at least attributing weights for each type of user behavior data and summing them together.

In some embodiments, computation element 630 may include (not shown in FIG. 6): An average value computation element that is configured to determine the average interest level value of the time sequence; a threshold computation element that is configured to determine the threshold interest level value based on the average interest level value; an interest level comparison element that is configured to perform comparisons of each interest level value to the average interest level value and threshold interest level value; a comparison results execution element that is configured to set the purchase peak probabilities of time intervals whose interest level values are lower than the average interest level value to 0, to set the purchase peak probabilities of time intervals whose interest level values are higher than the threshold interest level value to 1, and to set the purchase peak probabilities of time intervals whose interest level values are between the average interest level and the threshold interest level to a probability value determined using a formula with both the average and threshold interest level values.

In some embodiments, output element 680 may include (not shown in FIG. 6): An initial information retrieval element that is configured to retrieve initial product recommendation information outputted by the recommendation system; an initial information adjustment element that is configured to adjust the ranking of product information included in the initial recommendation information according to the ranking of purchase peak probabilities; a display element that is configured to display the recommended product information (e.g., by appropriately formatting the information to be displayed at a website by a web browser). In some embodiments, output element 680 could include a recommendation information retrieval element that is configured to retrieve recommendation information for a predetermined number of products from the ranking results in order from highest to lowest; a recommendation information output element that is configured to enter the recommendation information for the predetermined number of products into the recommendation system; the recommendation system that is configured to output product recommendation information after processing the recommendation information for a predetermined number of products.

The elements described above can be implemented as software components executing on one or more general purpose processors, as hardware such as programmable logic devices, and/or Application-Specific Integrated Circuits designed to perform certain functions or a combination thereof. In some embodiments, the elements can be embodied by a form of software products which can be stored in a nonvolatile storage medium (such as optical disk, flash storage device, mobile hard disk, etc.), including a number of instructions for making a computer device (such as personal computers, servers, network equipment, etc.) implement the methods described in the embodiments of the present invention. The elements may be implemented on a single device or distributed across multiple devices. The functions of the elements may be merged into one another or further split into multiple sub-elements.

As can be seen through the description of the implementation means above, technical personnel in this field can clearly understand that the present disclosure can be realized with the aid of software plus the necessary common hardware platform. Based on such an understanding, the technical proposal of the present application, whether intrinsically or with respect to portions that contribute to the existing technology, is realizable in the form of software products; said computer software products can be stored on storage media, such as ROM/RAM, diskettes, and compact discs, and include a certain number of commands used to cause a set of computing equipment (which could be a personal computer, server, or network equipment) to execute the means or certain portions of the means described in the embodiments of the present disclosure.

Each of the embodiments contained in the present application is described in a progressive manner, and the descriptions thereof may be mutually referenced for portions of each embodiment that are identical or similar; the explanation of each embodiment focuses on areas of different from the other embodiments. Particularly in regard to the system embodiment, because it is fundamentally similar to the method embodiment, the description is relatively simple; portions of the explanation of the method embodiment can be referred to for the relevant aspects.

The present application can be used in many general purpose or specialized computer system environments or configurations. Examples of these are: personal computers, servers, handheld devices or portable equipment, tablet-type equipment, multiprocessor systems, microprocessor-based systems, set-top boxes, programmable consumer electronic equipment, networked PCs, minicomputers, mainframe computers, distributed computing environments that include any of the systems or equipments above, and so forth.

The present application can be described in the general context of computer executable commands executed by a computer, such as a program module. Generally, program modules include routines, programs, objects, components, data structures, etc., to execute specific tasks or achieve specific abstract data types. The present application can also be carried out in distributed computing environments, such that in distributed computing environments, tasks are executed by remote processing equipment connected via communication networks. In distributed computing environments, program modules can be located on storage media at local or remote computers that include storage equipment.

Although the present application has been depicted through the use of the embodiments, ordinary technical personnel in this field know that there are many permutations and variants of the present disclosure which do not depart from the spirit of the present disclosure. We hope that the claims attached include these permutations and variations without departing from the spirit hereof.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
a processor configured to:
retrieve user behavior data associated with a predetermined statistical period;
sort the user behavior data into one or more groups of data corresponding to one or more types of products based at least in part on associated product identifiers;
determine a plurality of interest levels associated with the predetermined statistical period for at least one or more groups of data;
determine a plurality of purchase peak probabilities using at least the plurality of interest levels, wherein a purchase peak probability is associated with a predicted likelihood of user interest in receiving recommendations associated with a type of product;
rank at least a portion of the plurality of purchase peak probabilities in response to receipt of an indication to present recommendation information; and
present recommendation information based at least in part on the ranked at least portion of the plurality of purchase peak probabilities; and
a memory coupled to the processor and configured to provide the processor with instructions.

2. The system of claim 1, wherein recommendation information includes information associated with one or more products associated with an electronic commerce website.

3. The system of claim 1, wherein the user behavior data includes data associated with one or more types of products.

4. The system of claim 1, wherein the user behavior data includes data associated with one or more of the following: click traffic, page views, browsing times, and purchase amounts.

5. The system of claim 1, wherein the processor is further configured to generate one or more data summary tables for the retrieved user behavior data.

6. The system of claim 1, wherein each of the one or more groups of data corresponds to a type of product and wherein the type of product is associated with one product identifier.

7. The system of claim 1, wherein the plurality of interest levels is associated with a type of product.

8. The system of claim 7, wherein to determine the plurality of interest levels associated with a type of product includes to:
determine a time sequence associated with each type of user behavior data associated with the type of product, wherein each time sequence associated with a type of user behavior data includes a plurality of time intervals that each corresponds to a value associated with the type of user behavior data associated with that time interval; and
use one or more time sequences associated with user behavior data associated with the type of product to determine a time sequence associated with interest levels for the type of product.

9. The system of claim 1, wherein the plurality of purchase peak probabilities includes a time sequence comprising a plurality of time intervals that each corresponds to an interest level value.

10. The system of claim 9, wherein the processor is further configured to:
determine an average interest level value and a threshold interest level value based at least in part on the plurality of purchase peak probabilities;
compare an interest level value corresponding to one of the plurality of time intervals with one or both of the average interest level value and the threshold interest level value; and
determine a purchase peak probability value corresponding to the one of the plurality of time intervals based on said comparisons.

11. The system of claim 1, wherein an indication to present recommendation information is received in association with one or more of the following: browsing at a webpage at an electronic commerce website and clicking on a particular element on the webpage.

12. The system of claim 1, wherein the indication to present recommendation information includes a time interval.

13. The system of claim 12, wherein to rank at least a portion of the plurality of purchase peak probabilities includes to rank the at least portion of the plurality of purchase peak probabilities that is associated with the time interval among corresponding portions of other plurality of purchase peak probabilities.

14. The system of claim 13, wherein to present recommendation information includes to present recommendation information associated with one or more products associated with ranked portions of pluralities of purchase peak probabilities that are associated with higher positions at a ranked list.

15. The system of claim 1, wherein to present recommendation information includes to adjust existing recommendation information using the plurality of purchase peak probabilities.

16. A method, comprising:
retrieving user behavior data associated with a predetermined statistical period;
sorting the user behavior data into one or more groups of data corresponding to one or more types of products based at least in part on associated product identifiers;
determining a plurality of interest levels associated with the predetermined statistical period for at least one or more groups of data;
determining a plurality of purchase peak probabilities using at least the plurality of interest levels, wherein a purchase peak probability is associated with a predicted likelihood of user interest in receiving recommendations associated with a type of product;
ranking at least a portion of the plurality of purchase peak probabilities in response to receipt of an indication to present recommendation information; and
presenting recommendation information based at least in part on the ranked at least portion of the plurality of purchase peak probabilities.

17. The method of claim 16, wherein the plurality of interest levels is associated with a type of product and further comprising:
determining a time sequence associated with each type of user behavior data associated with the type of product, wherein each time sequence associated with a type of user behavior data includes a plurality of time intervals that each corresponds to a value associated with the type of user behavior data associated with that time interval; and
using one or more time sequences associated with user behavior data associated with the type of product to determine a time sequence associated with interest levels for the type of product.

18. The method of claim 16, wherein the plurality of purchase peak probabilities includes a time sequence comprising a plurality of time intervals that each corresponds to an interest level value.

19. The method of claim 18, further comprising:
determining an average interest level value and a threshold interest level value based at least in part on the plurality of purchase peak probabilities;
comparing an interest level value corresponding to one of the plurality of time intervals with one or both of the average interest level value and the threshold interest level value; and
determining a purchase peak probability value corresponding to the one of the plurality of time intervals based on said comparisons.

20. A computer program product, the computer program product being embodied in a computer readable medium and comprising computer instructions for:
retrieving user behavior data associated with a predetermined statistical period;
sorting the user behavior data into one or more groups of data corresponding to one or more types of products based at least in part on associated product identifiers;
determining a plurality of interest levels associated with the predetermined statistical period for at least one or more groups of data;
determining a plurality of purchase peak probabilities using at least the plurality of interest levels, wherein a purchase peak probability is associated with a predicted likelihood of user interest in receiving recommendations associated with a type of product;
ranking at least a portion of the plurality of purchase peak probabilities in response to receipt of an indication to present recommendation information; and
presenting recommendation information based at least in part on the ranked at least portion of the plurality of purchase peak probabilities.
